(19) United States
(12) Patent Application Publication
(10) Pub. No.: US 2013/0282281 A1
(43) Pub. Date: Oct. 24, 2013

(54) Cartography System and Method with Representation by Actions

(71) Applicant: Pierre Hayot, Clermont-Ferrand Cedex 9 (FR)

(72) Inventor: Pierre Hayot, Clermont-Ferrand Cedex 9 (FR)

(21) Appl. No.: 13/880,965

(22) PCT Filed: Oct. 19, 2011
(86) PCT No.: PCT/IB2011/002498

§ 371 Date: Jul. 2, 2013

(30) Foreign Application Priority Data
Oct. 21, 2010 (FR) 1004166

(51) Int. Cl. G01C 21/36

(52) U.S. Cl. CPC G01C 21/3626
USPC 701/533

(57) ABSTRACT

Method for automatically generating route maps, comprising receiving a route to be mapped (101); performing a formatting of the data of the route for arrangement on a support comprising defining an orientation axis serving to orient the arrangement of the instructions on the support (202); defining at least two zones on the support (203), substantially side by side one another, aligned substantially along the orientation axis; splitting the route to be mapped into a plurality of unit sections (300); for each section, formatting the schematic representation of the manoeuvre and portion of route associated with a scale corresponding to the detected axial spacing (304) and aligning the paired route elements on each side of the orientation axis (305). Also disclosed is a corresponding system for generating route maps.

### TECHNICAL FIELD OF THE INVENTION

The present invention relates to a method and a system for automatically generating route maps. It relates more particularly to a method making it possible to generate complete and exhaustive route maps, using a restricted memory space.

### PRIOR ART

The devices, method and system for preparing route maps are well known and have even become commonly used tools for a considerably significant number of road users.

For example, document WO2006/042688 describes a method for generating routes indicating, in addition to an optimal route between two given points, the neighbouring points along this route. In addition to the presence of the neighbouring points, which make it possible to facilitate the following of the route by virtue of the tagging of easily viewed points along the track, this document describes a conventional mode of presenting the routes that are prepared before departure, namely a printout on one or more pages comprising written instructions, and one or more pages comprising road maps on which the route established is featured, for example by highlighting. Although this type of tool is useful for preparing a trip, by allowing the driver to take overall cognizance of the forthcoming run, several drawbacks are to be noted during the phase of following the route on the road. For a driver or for a passenger acting in the guise of copilot, the manipulation of several pages for one and the same route sector is very impractical. Moreover, the reading and the understanding of the detailed instructions, without precise relation with the map of the route to be performed, can sometimes be irksome. Finally, precise visual details on the manoeuvres to be performed are in general absent, sometimes causing risks of error in interpreting the instructions. Finally, if such a route, with complete cartographic format, must be saved or transmitted to a portable device, the memory capacity required is relatively significant, and this may restrict the list of compatible apparatuses.

Document FR 2 796 746 describes a system for displaying a route comprising means for generating map information of limited region in the form of a band extending along a route. The width of the band is adapted as a function of the information storage capacity of the device. Such a device does not make it possible, however, to optimize the format of the map since it merely entails undertaking data extraction while preserving the initial format. Moreover, no explanation or instruction is provided to facilitate the following of this route.

Document US2006/0271277 describes a journey or route planning map comprising the display of a route and of elements complementary to this route, such as information relating to hotels, restaurants, tourist sites, etc. These complementary data are beneficial for ensuring the comfort and contentment of the passengers of the vehicle, but do not make it possible to facilitate the following of the route as such.

Thus, generally, the existing methods are not very ergonomic and are generally greedy in terms of memory capacity.

To alleviate these various drawbacks, the invention envisages various technical means.

### DISCLOSURE OF THE INVENTION

Firstly, a first object of the invention consists in envisaging a method for generating route maps making it possible to generate route maps occupying reduced or minimized memory space.

Another object of the invention consists in envisaging a method for generating route maps with optimized ergonomics, facilitating understanding and use, in complete safety.

Still another object of the invention consists in envisaging a system for generating route maps occupying a minimum area, but without affecting the clarity or the general quality of the data contained.

Accordingly, the invention envisages a method for automatically generating route maps for system for generating route maps having access to digital road mapping data in conjunction with at least one given geographical zone and making it possible to determine a plurality of maps of routes in this zone, comprising the steps consisting in:

receiving a route to be mapped;

detecting, with the aid of a manoeuvre detection module, the manoeuvres making it possible to perform the route;

obtaining, with the aid of a module for determining instructions, the data of instructions corresponding to the manoeuvres to be performed;

performing an extraction of the schematic representations for each manoeuvre;

pairing the written instructions and the corresponding schematic representations;

with the aid of a route splitting module, splitting the route to be mapped into a plurality of unit sections, each unit section comprising an entry point followed by a node corresponding to a manoeuvre to be performed associated with a paired written instruction and a paired schematic representation and an exit point;

performing a formatting of the data of the route for arrangement on a support comprising the steps consisting in:
defining, with the aid of a module for defining axis of orientation and zones of the support, an orientation axis serving to orient the arrangement of the data of the route on the support and two zones on the support substantially side by side one another aligned substantially along the orientation axis;
for each unit section, formatting, with the aid of a module for formatting route elements, the schematic representation in such a way that the characteristics of arrangement of the segments make it possible to obtain a schematic representation suited to the area of the zone of the support that is designed to accommodate the said schematic representation while making it possible to align the paired route elements on each side of the orientation axis;
aligning the written instructions and the paired schematic representations on either side of the orientation axis.

By virtue of this method, the cartographic data are formatted in such a way that the segments corresponding substantially to the run making it possible to follow an instruction are arranged axially substantially opposite the said instruction. Such an implementation allows substantial space savings by avoiding the use of useful area to display data which are not indispensable, or are indeed hardly useful, if at all, for following the route. The use of a schematic representation using a few key segments, rather than a set of maps of the zone covered by the route and parts of this zone, makes it possible to considerably reduce the memory capacity required to store and/or use the maps produced. Thus, a larger number of devices are liable to be able to display the maps generated by the method.

The method confers very great flexibility in respect of the arrangement, notably the orientation of the manoeuvres. The reading and the understanding of the route are greatly facilitated. The cartographic representations obtained according to the method make it possible to represent the successive manoeuvres schematically at various levels of magnification and with a general alignment along the orientation axis.

In an advantageous manner, the axial tagging step making it possible to align the associated schematic representation is advantageously carried out by measuring the axial spacing required for positioning the instruction on the support.

According to an advantageous embodiment, the schematic representation comprises solely the segments identified for achieving the route. The extraction of the route from the remainder of the cartographic elements confers total freedom of representation of the segments, both from the dimensional and angular point of view.

According to another advantageous embodiment, the formatting of the schematic representation comprises a transformation step making it possible to modify at least one of the characteristics of arrangement of at least part of the segments as a function, on the one hand, of the axial positions of the instructions and, on the other hand, of the area available for the schematic representation.

The characteristics of arrangement of the segments advantageously comprise:

the angles of positioning of the segments with respect to one another;

the profiles of the segments;

the relative lengths of the segments.

The fact of modifying the relative arrangement of the segments, their length and/or their angular position, and thus of obtaining a transformed and adapted representation of the route, does not affect other elements as if the route were integrated into a map. For the user, who does not seek a faithful representation of physical reality, but rather an easy-to-interpret directional guide, these modifications of scale, shape and/or angle engender only few or no drawbacks. Furthermore, these modifications are almost imperceptible from the vehicle while following the route.

In an alternative embodiment, the schematic representation comprises in addition segments directly connected to those of the envisaged route. The connected segments concerned are preferably those where manoeuvres are envisaged and those preceding a manoeuvre of crossover type with level crossing.

According to another advantageous embodiment, each section comprises in addition a portion of route with no manoeuvre to be performed. This portion preferably extends substantially as far as the following manoeuvre. By virtue of the method according to the invention, this portion is dimensioned as a function of the available area. There is no requirement to use additional area, rendering the representation of the route needlessly long.

According to an advantageous embodiment, if these operations cannot be performed in a prior manner or by an external device, the method comprises the steps for detecting the manoeuvres making it possible to perform the route and for obtaining the data of instructions corresponding to the manoeuvres to be performed.

In an advantageous manner, the method moreover comprises a step of arranging the segments of the route so as to afford the schematic representation of the route an orientation substantially along the orientation axis.

According to an advantageous embodiment, the set of the entry and/or exit points comprises neighbouring angular positions. This makes it possible to improve the ergonomics of the route map, by offering the most standard possible format of the manoeuvres. The readability of the map is thereby greatly improved. According to an advantageous example of this embodiment in which the entry points are in the lower portion of the display support (or printout support), this type of implementation allows display of the data in correspondence with a view corresponding substantially to the heading followed by the vehicle, that is to say a view in which the axis of the support is substantially aligned with the axis of the vehicle.

In another advantageous embodiment, the distance to be travelled between two instruction points is schematically integrated along the orientation axis for each portion of route. The orientation axis is advantageously represented between the two sides of the support, or else on one of the sides, on the left or on the right of the support.

According furthermore to an advantageous embodiment, the nodes of roundabouts are grouped together to form just a single manoeuvre, so that, in roundabouts, no splitting is performed before the exit.

According furthermore to an advantageous embodiment, no splitting is performed between the manoeuvres of one and the same urban zone.

The invention also envisages a system for generating route maps for the implementation of the method mentioned above, comprising access to road mapping data in conjunction with at least one given geographical zone and making it possible to determine a plurality of maps of routes in this zone, at least one microprocessor and at least one work memory, a route calculation module, and comprising moreover:

a module for defining axis of orientation and zones of the support, for defining an orientation axis serving to orient the arrangement of the instructions on the support;

a route splitting module, for splitting the route to be mapped into a plurality of unit sections;

a module for formatting route elements, for formatting the schematic representation in such a way that the characteristics of arrangement of the said segments make it possible to obtain a schematic representation suited to the area of the zone of the support that is designed to accommodate the said schematic representation, while making it possible to align the paired route elements on each side of the orientation axis.

According to an advantageous embodiment, the system for generating route maps moreover comprises an analysis module for analysing the map display support, to determine the area available to display the route map.

According to another advantageous embodiment, the system for generating route maps moreover comprises a module for transforming the segments, making it possible to modify at least one of the characteristics of arrangement of at least part of the segments as a function, on the one hand, of the axial positions of the instructions and, on the other hand, of the area available for the schematic representation of the segments.

According furthermore to an advantageous embodiment, the system for generating route maps comprises moreover:

a manoeuvre detection module, for detecting the manoeuvres to be performed to travel the route;

an instructions determination module, for providing the instructions corresponding to each of the manoeuvres.

### DESCRIPTION OF THE FIGURES

All the embodiment details are given in the description which follows, supplemented with FIGS. 1 to 12, presented solely for the purpose of nonlimiting examples, and in which:

FIG. 1 is a schematic representation of a route map generating system according to the invention;

FIGS. 2A and 2B are schematic representations complementary to the system of FIG. 1;

FIG. 3 is another schematic representation of a route map generating system, showing a delocalized work environment;

FIG. 4 is a functional flowchart illustrating the main steps of a route map generating method according to the invention;

FIGS. 5A, 5B and 5C are examples of route maps according to the prior art;

FIG. 6 illustrates an example of an intermediate step of the method according to the invention;

FIG. 7 presents an exemplary route map generated with the aid of a route map generating method and system according to the invention;

FIG. 8 presents another exemplary route map generated with the aid of a route map generating method and system according to the invention;

FIG. 9 presents another exemplary route map generated with the aid of a route map generating method and system according to the invention with the direction of reading of the schematic representations from top to bottom of the support;

FIG. 10 presents another exemplary route map generated with the aid of a route map generating method and system according to the invention for which the entry points of the schematic representations are located in one and the same zone for each diagram;

FIG. 11 presents another exemplary route map generated with the aid of a route map generating method and system according to the invention in which manoeuvres have been grouped together;

FIG. 12 presents another exemplary route map generated with the aid of a route map generating method and system according to the invention in which the direction of reading is from bottom to top of the support.

### DETAILED DESCRIPTION OF THE INVENTION

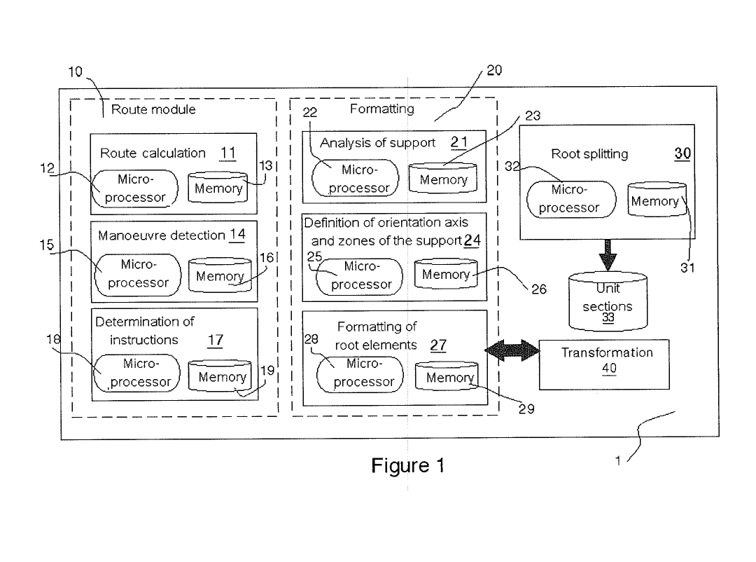

FIG. 1 presents an example of an embodiment of a route map generating system 1. Depicted on the one hand is a route module 10, designed to generate all the data in conjunction with the route for which a map must be produced. The route module 10 comprises a route calculation module 11, provided with calculation means such as a microprocessor 12 and with a work memory 13, a manoeuvre detection module 14, provided with calculation means such as a microprocessor 15 and with a work memory 16, and with an instruction determination module 17, provided with calculation means such as a microprocessor 18 and with a work memory 19. According to various alternative embodiments, the calculation means 12, 15 and 18, just like the work memories 13, 16 and 19, can be centralized for all the modules or the whole of the route map generating system, or else be arranged in an external manner, with connection to the various modules.

The route calculation module 11 operates in a manner known per se, with the aid of an algorithm for determining the shortest path between two points, such as Dijkstra or the like. Such an algorithm makes it possible, with the aid of a microprocessor and of the required instructions, to perform the exploration of a very large number of possibilities (a few tens or hundreds for zones with low density and/or for short routes with a few hundred thousand, or indeed more, for zones with high density of roads and/or for long routes), with the aim of electing an optimal route as a function of given criteria, such as the shortest route, or the fastest route, etc.

Once the route is known, a manoeuvre detection module 14 makes it possible to detect the manoeuvres to be performed along the route in question. The term manoeuvre is understood to mean mainly an action of driving a vehicle making it possible to select a given segment when the driver is faced with a possibility of committing his vehicle to a plurality of segments (at least two). The driver is faced with multiple possibilities of continuing his course, and a manoeuvre allows him to commit his vehicle as a function of the direction envisaged by the pre-established route. Thus, the module 14 performs a virtual run of the route established by the module 11, and identifies the points or nodes where multiple segments are joined up. This may involve road intersections, exit from or entry to motorways, and forks, etc. The manoeuvres are determined in a manner known per se. For a roundabout, it is understood that a plurality of simple manoeuvres are in general involved, from entry to the roundabout, and then to the crossing of each exit, each time involving a manoeuvre consisting either in remaining on the roundabout, or in exiting it, until actual exit from the roundabout. In the present document, roundabouts are considered to be a single manoeuvre, of the type “take the 3rd exit”, in fact consisting in a complex manoeuvre, as mentioned previously.

The module 17 for determining instructions performs the data associations between, on the one hand, the manoeuvres detected by the manoeuvre detection module 14, and on the other hand, the road data of the routes, so as to define instructions in the form of written data, allowing the driver to take cognizance of the usual data such as road names or numbers, the directions to be followed, landmarks, the distances to be travelled, and data relating to the manoeuvres to be performed, such as turn left or right, take the Xth exit, continue straight ahead, etc.

By virtue of the manoeuvre detection module 14 and the module for determining instructions 17, it is possible to obtain data pairs, or paired data, with, on the one hand, data relating to a manoeuvre to be displayed in the form of a diagram, and, on the other hand, data relating to the written instructions making it possible to perform the corresponding manoeuvre.

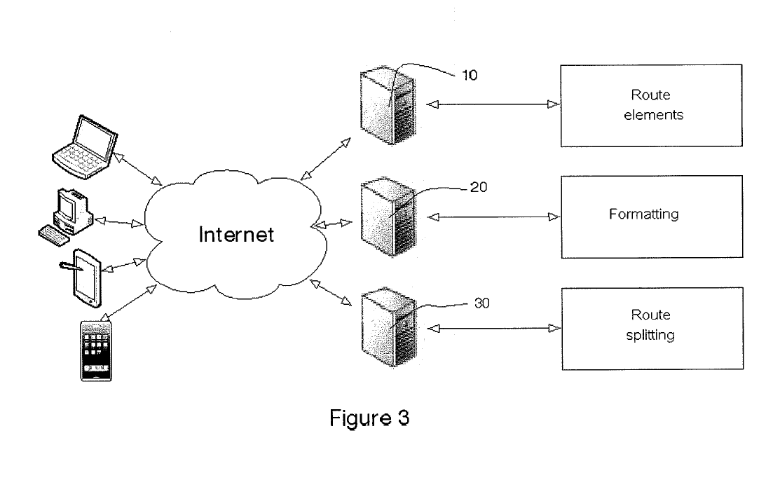

The route module 10 can be envisaged in a manner external to the route map generating system 1, either in proximity to one another, with direct connection, or remote from one another, with the connection means of known type such as Wifi, Wimax, by a network, such as the Internet or a cellular telephone network, etc. According to another alternative embodiment, such as shown in FIG. 3, a route module 10 can be common to a plurality of users using remote display devices, of portable type, such as telephones termed “Smartphones”, PDAs, guidance devices of GPS type or the like, laptops or tablet-type computers, etc, or fixed computers, such as a desktop computer.

According to other alternative embodiments, the route calculation module 11, and/or the manoeuvre detection module 14 and/or the module for determining instructions 17 are separate or remote, and linked by usual communication or connection means, such as mentioned previously. According to yet another alternative, the route calculation modules 11, the manoeuvre detection module 14, and the module for determining instructions 17 can also be combined into a single or two modules.

The formatting block 20 comprises a support analysis module 21, provided with calculation means such as a microprocessor 22 and with a work memory 23, a module for defining orientation axis and support zones 24, provided with calculation means such as a microprocessor 25 and with a work memory 26, and with a module for formatting route elements 27, provided with calculation means such as a microprocessor 28 and with a work memory 29. According to various alternative embodiments, the calculation means 22, 25 and 28, just like the work memories 23, 26 and 29, can be centralized for all the modules or the whole of the route map generating system, or else be arranged in an external manner, with connection to the various modules.

The support analysis module 21 detects the type and the display characteristics of the support envisaged for display of the route map, so that the format of the route map can be adapted. As a function of the data gathered by the support analysis module 21, the module for defining axis of orientation and zones of the support 24 defines firstly an orientation axis A-A, serving to define a preferential direction of orientation on the support, according to which the various manoeuvres of the route will be arranged or aligned. The orientation axis makes it possible to separate two zones 400 and 500 disposed side by side one another. These two zones are designed to contain the paired route elements: on the one hand, the written instructions, and on the other, the corresponding manoeuvres. The module for formatting route elements 27 performs the formatting of the paired route elements, in a format suited to the support used and as a function of the orientation axis defined.

The formatting module 20 can be envisaged in a manner external to the route map generating system 1, either in proximity to one another, with direct connection, or remote from one another, with the connection means of known type such as Wifi, Wimax, by a network, such as the Internet or a cellular telephone network, etc. According to another alternative embodiment, such as shown in FIG. 3, a formatting module 20 can be common to a plurality of users using remote display devices, of portable type, such as telephones termed “Smartphones”, PDAs, guidance devices of GPS type or the like, laptops or tablet-type computers, etc, or fixed computers, such as a desktop computer.

A route splitting module 30 performs a separation of the route to be displayed in a plurality of unit sections 510. The separation mode and criteria are presented in greater detail further on in this document. The unit sections generated are stored in a memory or unit for storing unit sections 33.

The route splitting module 30 can be envisaged in a manner external to the route map generating system 1, either in proximity to one another, with direct connection, or remote from one another, with the connection means of known type such as Wifi, Wimax, by a network, such as the Internet or a cellular telephone network, etc. According to another alternative embodiment, such as shown in FIG. 3, a route splitting module 30 can be common to a plurality of users using remote display devices, of portable type, such as telephones termed “Smartphones”, PDAs, guidance devices of GPS type or the like, laptops or tablet-type computers, etc, or fixed computers, such as a desktop computer.

A module for transforming the segments 40, making it possible to modify the characteristics of the segments as a function of the display format, is also envisaged. Such as described further on, this module makes it possible to adapt diverse characteristics of the segments, such as the shape, the length, the angle, etc, with respect to the adjacent elements, to make it possible to reduce the area required to dispose the schematic representation of the manoeuvre to be performed in a compact manner, without loss of the informative data required to ensure the following of the route. The fact that the manoeuvre displayed is extracted from the road map, and that only a few segments are presented rather than a conventional map, makes it possible to perform modifications of shapes without affecting the general arrangement of the map and its readability. The module 40 for transforming the segments is advantageously integrated with or linked to the module for formatting route elements 27.

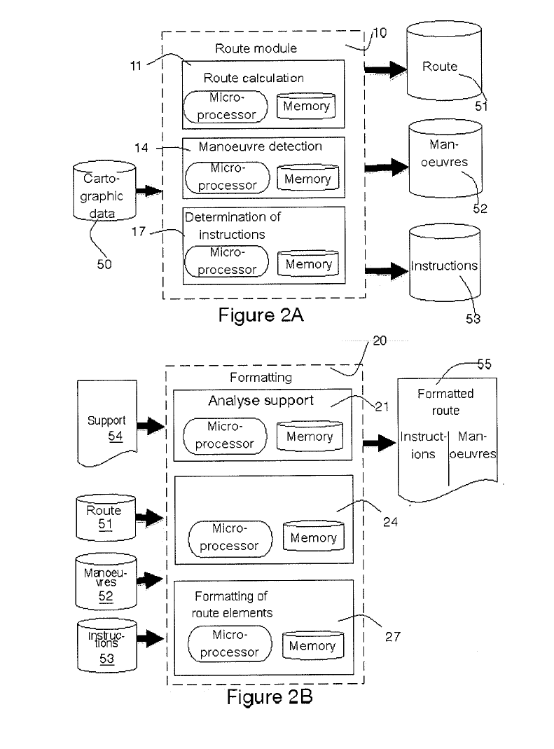

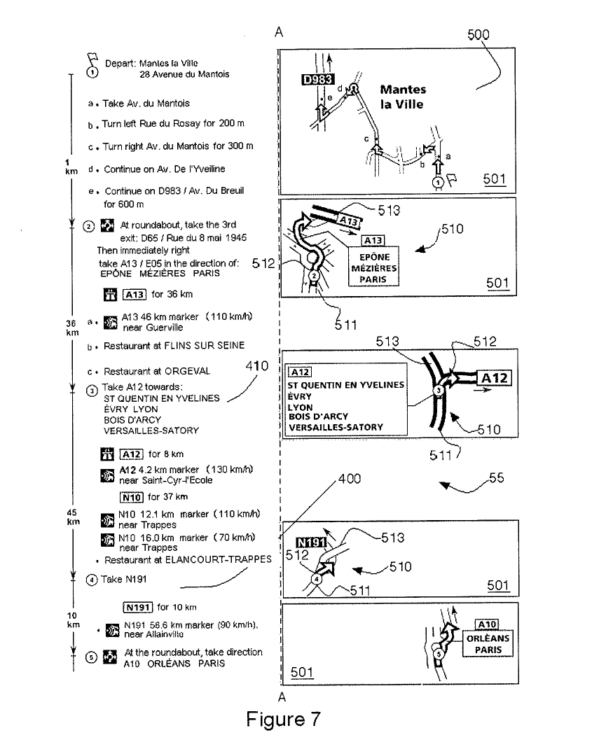

FIGS. 2A and 2B illustrate in a schematic manner the main functions of the route module 10 and of the formatting block 20. In FIG. 2A, it is noted that the raw cartographic data 50 are processed by the route module 10 to obtain the data of the route 51 to be performed, the data of the corresponding manoeuvres 52, and the data of the instructions 53 associated with these manoeuvres. In FIG. 2B is seen the formatting block 20 which, on the basis of the data 54 of the support, of the route 51, of the manoeuvres 52 and of the instructions 53, makes it possible to obtain a formatted route 55 comprising, on the one hand, instructions 410 and, on the other hand, schematic representations 501 of these instructions, such as presented in greater detail in conjunction with FIGS. 7 to 12.

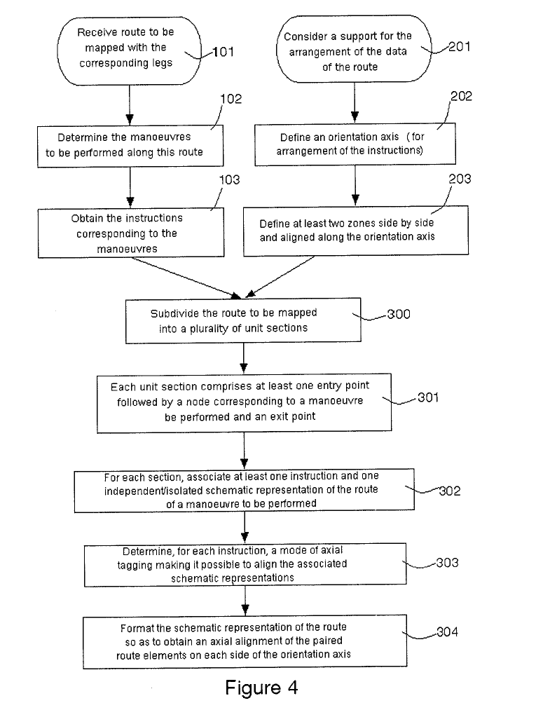

FIG. 4 presents, in a successive manner, the main steps of the method according to the invention. On the one hand, in steps 101 to 103, the data 51 in conjunction with the route are calculated. On the other hand, in steps 201 to 203, the data 54 relating to the type of support and its dimensional characteristics are obtained.

In a more detailed manner, in step 101, after reception by a route calculation module 11 of the digital cartographic data of the segments and of the nodes making it possible to reconstruct a representation of the calculated route, the manoeuvres to be performed along the route are determined in step 102 by a manoeuvre determination module 14. The instructions, notably written, relating to the identified manoeuvres are moreover identified in step 103 by a module for determining instructions 17. Pairs of paired route elements are thus obtained, consisting, on the one hand, of the written instructions making it possible to explain to the driver the manoeuvres to be performed throughout the route, and on the other hand, of the corresponding manoeuvres, for display in schematic form.

The data in conjunction with the best path to be travelled to constitute the route between the departure and arrival points can be calculated prior to step 101 by the route module 10 or by any other route determination device or system. According to an alternative embodiment, they can be calculated by the route module 10 during step 101.

The same holds for the data relating to the manoeuvres 52 and to the instructions 53, which can be obtained prior to the implementation of the method, or in the course of the first steps of the latter.

The data relating to the support 54 used for the display of the route map are provided to the analysis module of the support 21 so as to perform a detection of the type of support, such as for example paper for printing, or screen for display with the aid of the pixels of the screen, or any other mode making it possible to display or to show or to illustrate the route map produced. The analysis module of the support 21 makes it possible moreover to obtain the dimensions of the envisaged support. In the cases where a bilateral communication is not possible with the support, default values can be taken into account, such as for example an A4 format for a support by printing on paper. In order for the paired route elements to be able to be arranged in an optimal manner on the support, a step of defining an axis of orientation of the support is envisaged, advantageously with the aid of a module for defining axis of orientation and zones of the support 24. The module 24 envisages the orientation axis preferably in such a way that the latter can serve to delimit a zone on each side thereof. The two zones, 400 and 500 (FIG. 7 et seq.) can be of equal or unequal areas, as a function of the predefined parameters or as a function of choices left to the user, with the aid of formatting menus with which he is prompted.

In steps 300 and 301, the route to be mapped is split, by a splitting module 30, into a plurality of unit sections, which are stored in a memory 33 of unit sections. The splitting is performed so that each unit section 510 comprises at least one entry point 511, followed by a node 512 corresponding to a manoeuvre to be performed, and an exit point 513, as seen in FIG. 7 et seq.

In step 302, for each section, at least one instruction and one schematic representation which is isolated or extracted from the route of the corresponding manoeuvre to be performed so as to follow the route, are associated. The schematic representation is extracted from the global route to be performed. The extraction consists in preserving as a minimum the segments identified for achieving the route. The other segments of the road map, the cartographic background, the other data as well as the format of the road map, are preferably not represented. The fact of using only the directly useful segments rather than a conventional detailed cartographic representation on which the route is highlighted confers very great flexibility in configuring and formatting the manoeuvre to be displayed. Indeed, it is possible to shorten one or more segments, without modifying the length of other neighbouring or adjacent segments. The changes of length can be performed without taking account of scale constraints, so that certain segments are shortened more or less than others, while other segments may even be lengthened. The modifications may also involve changes of angles of certain segments, and even changes of shape. The fact that the route is isolated from the corresponding road map frees one from the constraint of compliance with the shapes, angles and dimensions of the segments.

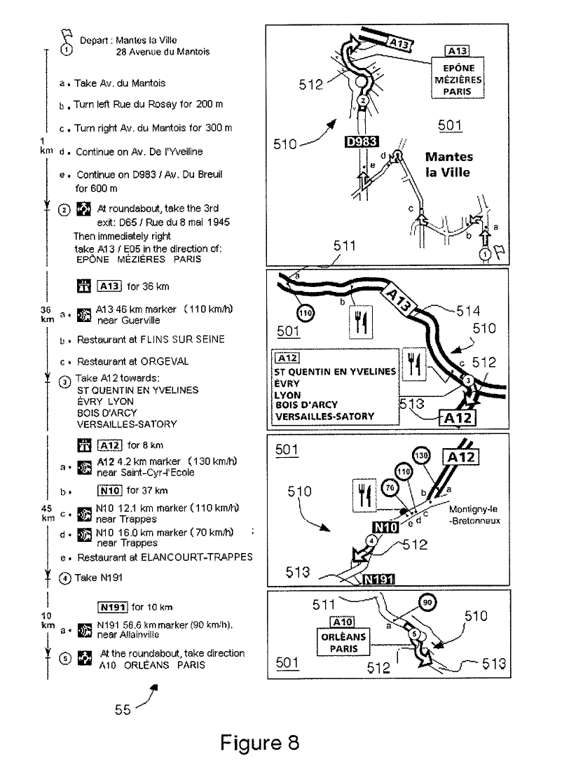

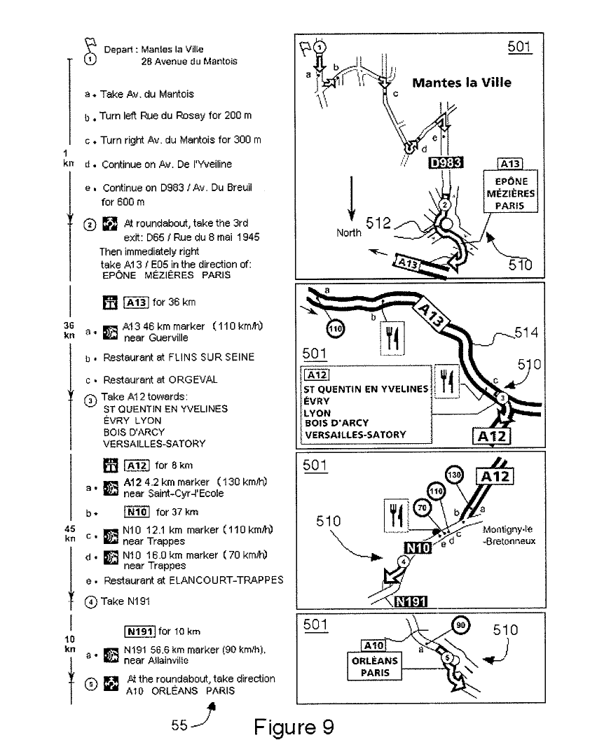

In an alternative embodiment, the schematic representation of the manoeuvre comprises in addition other segments, for example segments directly connected to those of the envisaged route, or significant segments, liable to serve as landmarks or references to facilitate the following of the route. Segments where forthcoming manoeuvres are envisaged are also advantageously represented. Moreover, to facilitate the following of the route, the unit sections may comprise a portion of route with no manoeuvre to be performed 514 (FIGS. 8 and 9), downstream and/or upstream of the portion of route of the manoeuvre itself. These portions with no manoeuvre can be represented until the following manoeuvre.

In certain cases, such as for example for representations at substantially large scale for residential zones, zones of streets with no name or with names that are very hard to see from the road when the vehicle performing the route is moving, a plurality of unit sections are combined for representation on a single diagram. This makes it possible to avoid multiplying the number of diagrams of manoeuvres. Moreover, this type of grouping often corresponds to instructions written succinctly in series, of the type “turn left onto street XXX, and then right onto street YYYY”, etc. FIG. 7, described in detail further on, presents an example of such a combination.

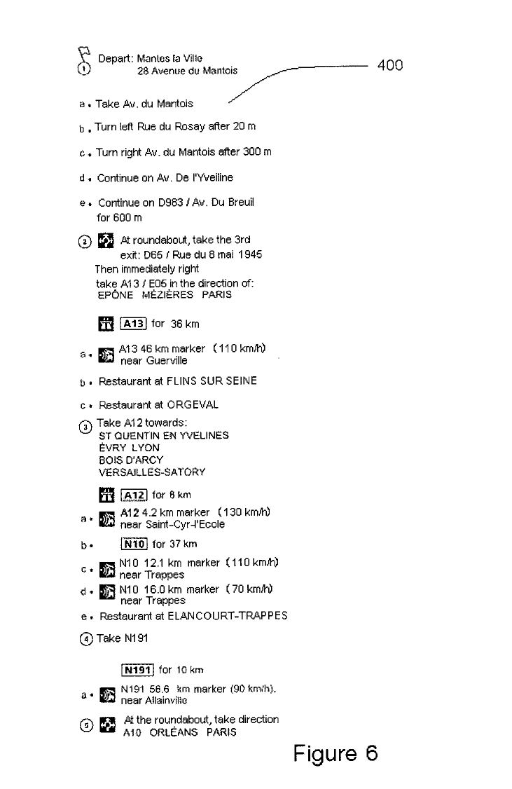

The map of the route is formatted so as to arrange, in the envisaged order of achievement, the pairs of paired route elements, with on one side 400 of the orientation axis A-A, the written instructions 410, and on the other side 500 of the orientation axis A-A, the schematic representations of the corresponding manoeuvres. The pairs are arranged in such a way that the corresponding elements are substantially aligned with one another. In the exemplary implementation illustrated in FIG. 4, in step 303, a mode of axial tagging making it possible to align the associated schematic representations is determined for each instruction. Accordingly, it is for example possible to evaluate or measure the axial spacing required to position the instructions of each of the sections one after another on one side of the orientation axis. A reference is thus obtained which makes it possible to adjust or to adapt the format of the diverse schematic representations of the manoeuvres as a function of the space available. FIG. 6 shows an example of a side 400 such as it would be displayable before formatting of the side 500 which will be established as a function of the axial arrangement of the first side 400.

Thus, in step 304, the schematic representations are formatted, with lengths, shapes, and angles of the various segments making it possible to integrate all the segments into the allotted space. An adapted representation is obtained, constructed as a function of an optimal use of the available area. A transformation module 40 is advantageously used for these operations of modifying segments. Moreover, the paired route elements, instructions on one side, and schematic representation on the other, are aligned to form an arrangement such that the manoeuvres are substantially opposite the corresponding instructions. Various alternatives for formatting route maps will be presented subsequently, by way of nonlimiting examples, in conjunction with FIGS. 7 to 12.

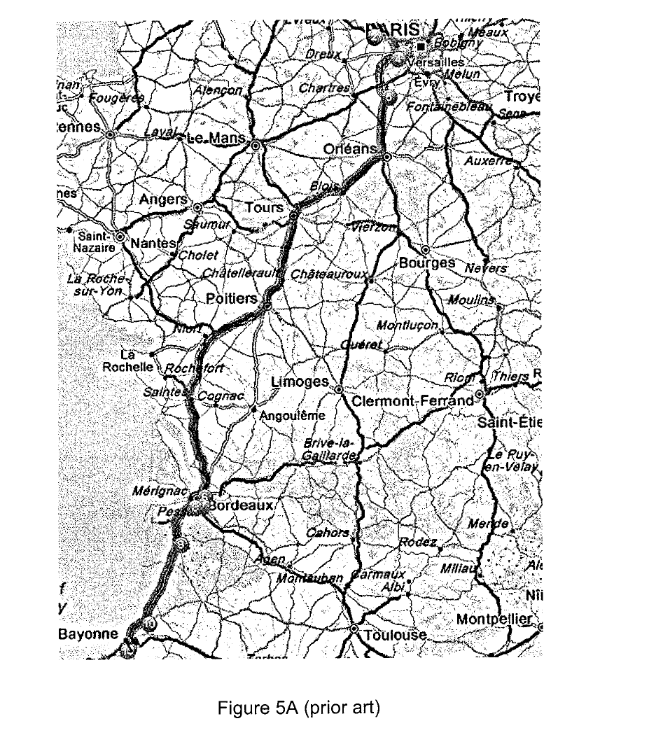

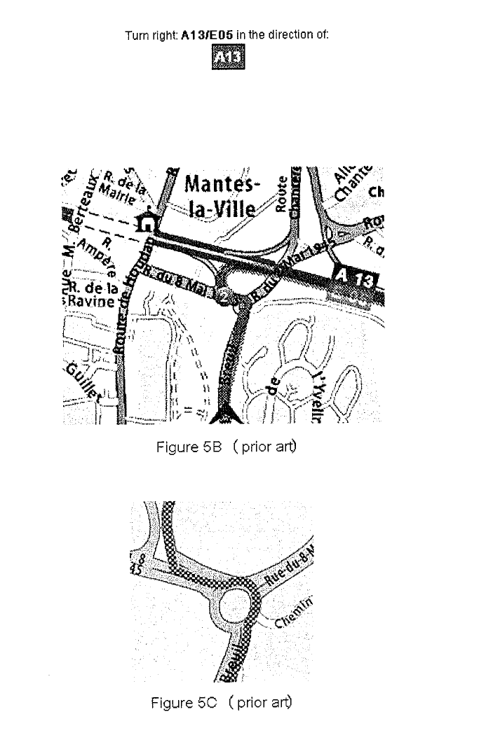

FIG. 5A shows an example of a route map according to the known calculation and display techniques. It is observed that the route to be travelled is indicated by a particular trace applied to the road of the route. This trace is applied to a conventional road map, comprising all the usual details such as place names, and sometimes the numbers of the main roads. In general such a map requires a significant memory capacity and exhibits restricted ergonomics. It is indeed often difficult to clearly distinguish the chosen run from the remainder of the data displayed. Moreover, on account of the use of a map of standardized format, it is not possible to perform modifications of shapes without affecting the nodes and segments situated in the surrounding zone.

FIG. 5B shows an example according to the prior art of displaying a manoeuvre with the corresponding textual data. Here again, the necessary use of the set of detailed maps of this type involves the making available of significant memory capacity.

FIG. 5C illustrates an exemplary detailed display according to the prior art of a manoeuvre, by magnification of the zone where the manoeuvre to be performed is situated.

FIG. 7 presents a first exemplary formatting obtained by virtue of the method described above. Depicted therein is an exemplary route map 55 generated with the aid of the route map generating method and system according to the invention. The orientation axis A-A serves to delimit the two zones in which the route elements are arranged: a first zone 400 for the data of instructions 410, preferably in written format, and a second zone 500 for the schematic representations 501 of the corresponding manoeuvres. The instructions, just like the schematic representations of the manoeuvres, are arranged in the envisaged chronological order of execution, along the orientation axis A-A, in this example, from top to bottom of the support, in accordance with the customary direction of reading. The direction of driving of the vehicle is however presented in the reverse direction, i.e. from bottom to top for this example. As mentioned previously, a unit section 510 comprises an entry point 511, a node 512 corresponding to a manoeuvre to be performed, and an exit point 513. For roundabouts or for certain crossroads, a node may be complex, that is to say comprise multiple possibilities of commitment regarding various segments.

As mentioned previously, the example of FIG. 7 illustrates how simple manoeuvres can be combined on one and the same schematic representation. In this example, the first schematic representation relates to a run of barely one km, such as shown on the left portion of the figure, with the aid of the arrows. Being simple manoeuvres, strung together substantially rapidly, grouping these manoeuvres makes it possible to simplify the schematic representation and especially to avoid multiplying the diagrams for one and the same sector of run.

The figure also illustrates the non-compliance with the cartographic scales, from one diagram to another. Thus, on substantially comparable support heights are shown initially a run of one km, then subsequently of 36 km, and then of 45 km. This example is aimed at providing the driver with the essential elements for performing the route, without pollution by data not required for following the run.

In the alternative embodiment presented in FIG. 8, the direction of driving of the vehicle varies according to the manoeuvres. In this example, the last three schematic representations 501 are presented with a downwards direction of driving, while the first schematic representation 501 is formatted with an upwards direction of driving. The unit sections 512 are moreover cut off after the exit point 513 of the manoeuvre. Moreover, diverse data complementary to the route, such as locations of restaurants and radars are moreover provided, on the one hand in the instruction zone 400 and, on the other hand, with a point corresponding to their location in the corresponding manoeuvring zone 500. This same figure moreover shows a portion of route with no manoeuvre 514, which can be adjoined to the schematic representation, to facilitate the general understanding of the route.

In the alternative presented in FIG. 9, the schematic representations 501 comprise directions of travel of the vehicle in the same direction as the direction of reading of the data of instructions 410, i.e. from top to bottom.

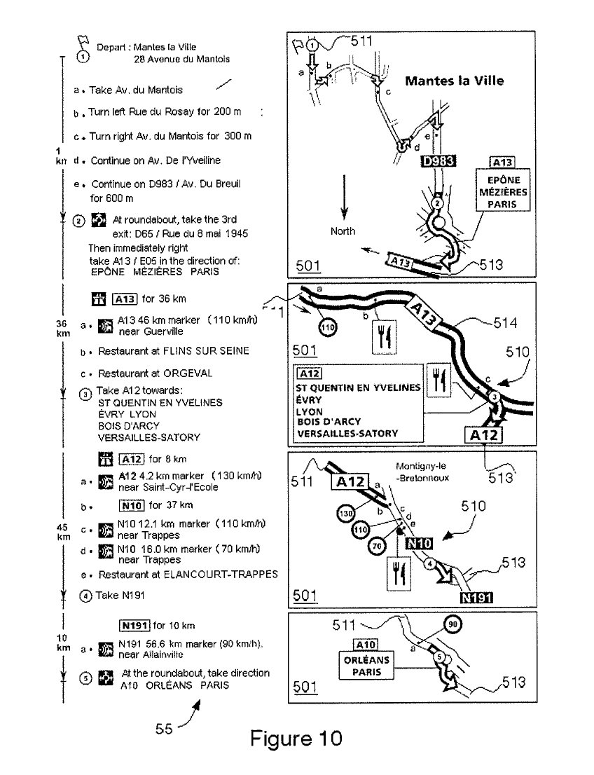

In the alternative presented in FIG. 10, for each schematic representation 501, the entry point 511 is situated substantially in the same sector, in this example, the top left corner. The exit point 513 is also advantageously situated in the same sector, in this example, the opposite corner, i.e. the bottom right corner. A standardized schematic configuration such as this makes it possible to improve the ergonomics and facilitates the reading and the understanding of the manoeuvres to be performed to follow the route flawlessly.

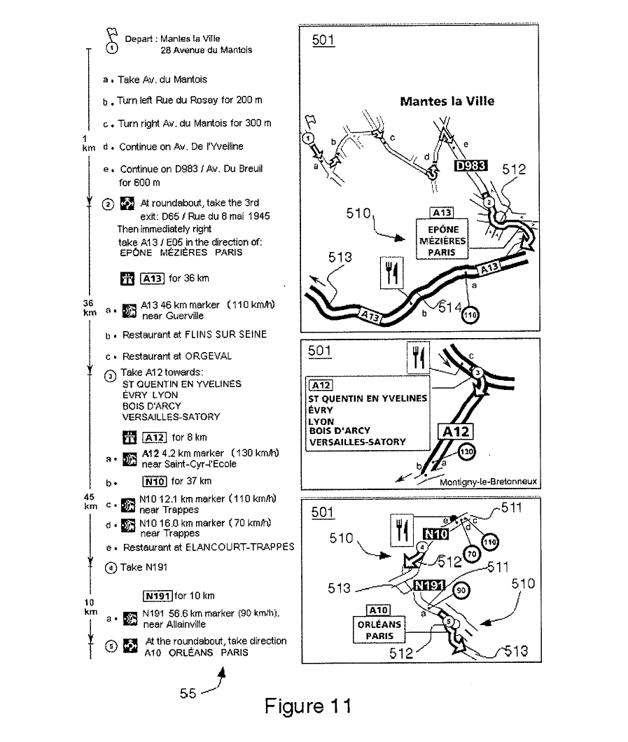

In the example of FIG. 11, a portion of route 514 with no manoeuvre is envisaged after a manoeuvre, in the first schematic representation 501. The third schematic representation 501 comprises several unit sections, appended to one and the same diagram.

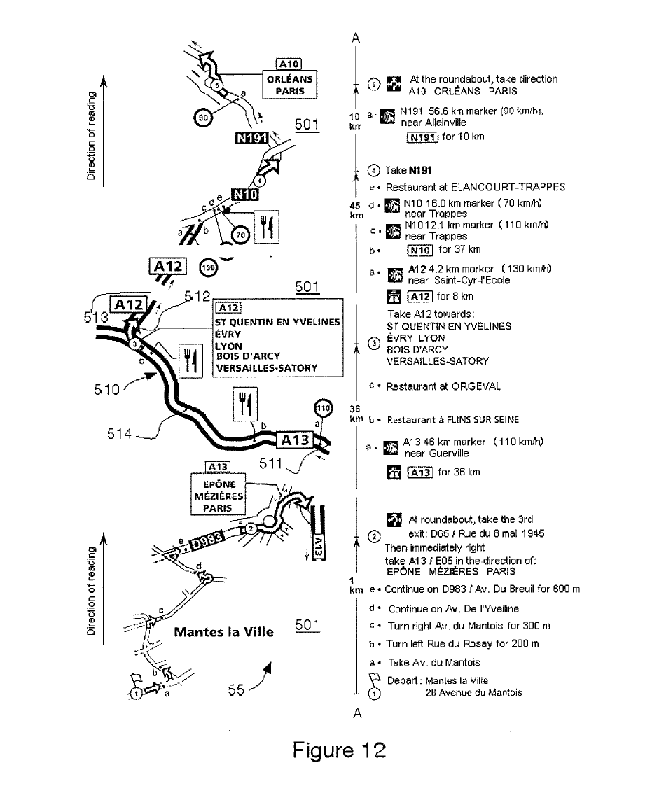

In the example illustrated in FIG. 12 the direction of reading is envisaged from bottom to top of the support, so as to correspond to a representation of the route with the road in front of the vehicle. Such a representation is very realistic and instinctive and therefore easy to interpret, even with a minimum of data. Moreover, such a type of arrangement corresponds to an increasingly widespread mode, namely the cartographic representation used for devices for mobile guidance of GPS type.

In the examples of FIGS. 7 to 12, the distances between the manoeuvres are indicated with the aid of arrows in conjunction with the schematic representations 501. In FIGS. 7 to 11, these distances are indicated by arrows comprising indications of the number of kms to be travelled between two manoeuvres. In FIG. 12, these distances are positioned directly along the orientation axis A-A. Also in the examples of FIGS. 8 to 12, in addition to the written instructions corresponding to the manoeuvres, some informative data, such as for example tourist data, the locations of certain radars, petrol stations, etc., can also be envisaged, for the purposes of convenience of the driver and/or the passengers.

The Figures and their descriptions given hereinabove illustrate the invention rather than limiting it. In particular, the invention and its various alternatives have just been described in conjunction with a particular example of format comprising an orientation axis in the vertical direction of the support.

Nonetheless, it is obvious to a person skilled in the art that the invention can be extended to other embodiments in which, as alternatives, an orientation axis is envisaged according to another orientation, for example transverse or diagonal.

The reference signs in the claims do not have any limiting character. The verb “comprise” does not exclude the presence of elements other than those listed in the claims. The word “a” or “an” preceding an element does not exclude the presence of a plurality of such elements.

1. A method for automatically generating route maps for system for generating route maps having access to digital road mapping data in conjunction with at least one given geographical zone and making it possible to determine a plurality of maps of routes in this zone, comprising:
receiving a route to be mapped comprising a plurality of segments;
detecting, with the aid of a manoeuvre detection module, the manoeuvres making it possible to perform the route, each manoeuvre corresponding to an action of driving a vehicle making it possible to select a given segment when the driver is faced with a possibility of committing his vehicle to a plurality of segments;
obtaining, with the aid of a module for determining instructions, the data of instructions corresponding to the manoeuvres to be performed;
performing an extraction of the schematic representations for each manoeuvre;
pairing the written instructions and the corresponding schematic representations;
with the aid of a route splitting module, splitting the route to be mapped into a plurality of unit sections, each unit section comprising an entry point followed by a node corresponding to a manoeuvre to be performed associated with a paired written instruction and a paired schematic representation and an exit point;
performing a formatting of the data of the route for arrangement on a support comprising:
defining, with the aid of a module for defining axis of orientation and zones of the support, an orientation axis serving to separate two zones disposed side by side one another, these two zones being designed to contain the paired route elements: on the one hand, the written instructions, and on the other, the corresponding manoeuvres;
for each unit section, formatting, with the aid of a module for formatting route elements, the schematic representation in such a way that the characteristics of arrangement of the segments make it possible to obtain a schematic representation suited to the area of the zone of the support that is designed to accommodate the said schematic representation while making it possible to align the paired route elements on each side of the orientation axis; and
aligning the written instructions and the paired schematic representations on either side of the orientation axis.

2. The method for automatically generating route maps according to claim 1, wherein the formatting of the schematic representation comprises a transformation step making it possible to modify at least one of the characteristics of arrangement of at least part of the segments as a function, on the one hand, of the axial positions of the written instructions and, on the other hand, of the area available for the schematic representation.

3. The method for automatically generating route maps according to claim 2, wherein the characteristics of arrangement of the segments comprise:
the angles of positioning of the segments with respect to one another;
the profiles of the segments;
the relative lengths of the segments.

4. The method for automatically generating route maps according to claim 1, wherein each section comprises in addition a portion of route with no manoeuvre to be performed.

5. The method for automatically generating route maps according to claim 1, further comprising a step of arranging the segments of the route so as to afford the schematic representation of the route an orientation substantially along the orientation axis.

6. The method for automatically generating route maps according to claim 1, wherein the set of the entry and/or exit points comprises neighbouring angular positions.

7. The method for automatically generating route maps according to claim 1, wherein the nodes of roundabouts are grouped together to form just a single manoeuvre, so that, in roundabouts, no splitting is performed before the exit.

8. The method for automatically generating route maps according to claim 1, wherein no splitting is performed between the manoeuvres of one and the same urban zone.

9. A system for generating route maps for the implementation of the method according to claim 1, comprising access to road mapping data in conjunction with at least one given geographical zone and making it possible to determine a plurality of maps of routes comprising a plurality of segments in this zone, at least one microprocessor and at least one work memory, a route calculation module, and further comprising:
a module for defining axis of orientation and zones of the support, for defining an orientation axis serving to separate two zones disposed side by side one another, these two zones being designed to contain the paired route elements: on the one hand, the written instructions, and on the other, the corresponding manoeuvres, each manoeuvre corresponding to an action of driving a vehicle making it possible to select a given segment when the driver is faced with a possibility of committing his vehicle to a plurality of segments;
a route splitting module, for splitting the route to be mapped into a plurality of unit sections; and
a module for formatting route elements, for formatting the schematic representation in such a way that the characteristics of arrangement of the said segments make it possible to obtain a schematic representation suited to the area of the zone of the support that is designed to accommodate the said schematic representation, while making it possible to align the paired route elements on each side of the orientation axis.

10. The system for generating route maps according to claim 9, further comprising an analysis module for analysing the map display support, to determine the area available to display the route map.

11. The system for generating route maps according to claim 9, further comprising a module for transforming the segments, making it possible to modify at least one of the characteristics of arrangement of at least part of the segments as a function, on the one hand, of the axial positions of the instructions and, on the other hand, of the area available for the schematic representation of the segments.

12. System for generating route maps according to claim 9, further comprising:
a manoeuvre detection module, for detecting the manoeuvres to be performed to travel the route; and
an instructions determination module, for providing the instructions corresponding to each of the manoeuvres.
